(19) United States
(12) Patent Application Publication
(10) Pub. No.: US 2003/0009479 A1
(43) Pub. Date: Jan. 9, 2003

(54) Employment placement method

(76) Inventor: Calvetta Phair, Mercer Island, WA (US)

Correspondence Address: Mr. Walter J. Tencza Jr., Suite 3, 10 Station Place, Metuchen, NJ, 08840, US

(21) Appl. No.: 10/119,234

(22) Filed: Apr. 9, 2002

Related U.S. Application Data
(60) Provisional application No. 60/302,559, filed on Jul. 3, 2001.

(51) Int. Cl. G06F 7/00

(52) U.S. Cl. 707/104.1

(57) ABSTRACT

A method for allowing individuals looking for employment placements to more efficiently seek those placements is disclosed. A more efficient method for allowing employment agencies to find appropriate candidates to fill needed employment positions is also disclosed. A first employment candidate processor which allows a first employment candidate to enter a first set of profile data and to send the first set of profile data to a central employment placement database is provided. The apparatus may also include a central employment placement processor which allows a first employment agency processor to access the central employment placement database to examine a plurality of sets of profile data corresponding to a plurality of employment candidates, which includes the first employment candidate.

### CROSS REFERENCE TO RELATED APPLICATIONS—CLAIM FOR PRIORITY

The present application hereby claims the priority of and incorporates by reference provisional application No. 60/302,559, inventor Calveffa Phair, filed on Jul. 3, 2001.

### FIELD OF THE INVENTION

This invention relates to improved methods and apparatus concerning finding employment and filling employment positions.

### BACKGROUND OF THE INVENTION

In the prior art, an individual seeking employment may go to an employment agency, such as ABC employment agency in Washington. This is particularly true if the individual is seeking temporary employment. For example, if the individual is an accountant seeking temporary employment, the individual will typically be required by ABC employment agency to fill out an application specifying past and present employment history; take an occupational assessment test for accountants; and take a basic skills test for evaluation of his or her English and math skills. The total time the individual may spend at the ABC employment agency may be about four and one-half hours. To expand his or her job search, the individual goes to XYZ employment in Washington and is required to provide the same employment request and required to take occupational assessment tests similar to the one taken at ABC employment agency. He or she may spend four and a half hours or so at XYZ temps in Washington. After 3 months of no possible employment prospects permanents or temporary, the individual may go to New York and may go to an ABC employment agency branch located in New York (an affiliate of ABC employment agency in Washington). The individual will typically be required to fill out the same employment applications and take the same skills assessment and occupational tests similar to the ones administered at ABC temps in Washington, duplicating all information pertaining to his past and present employment history.

The individual may inform the ABC employment agency branch in New York that his or her records are at the ABC employment agency branch in Washington however, due to the fact that there is currently no interchangeable procedure for streamlining such a process, he is required to repeat the process and spend an additional four and a half hours for taking tests and filling out applications previously provided to the ABC employment agency branch in Washington.

### SUMMARY OF THE INVENTION

The present invention in one or more embodiments provides a method for allowing individuals looking for employment placements to more efficiently seek those placements. The present invention also may provide a more efficient method for allowing employment agencies to find appropriate candidates to fill needed employment positions. One or more embodiments may be particularly useful for finding temporary positions and/or for filling temporary positions.

The present invention in one embodiment is comprised of an apparatus comprising a first employment candidate processor which runs a computer software program, which allows a first employment candidate to enter a first set of profile data and to send the first set of profile data to a central employment placement database. The apparatus may also include a central employment placement processor which runs a computer software program which allows a first employment agency processor to access the central employment placement database to examine a plurality of sets of profile data corresponding to a plurality of employment candidates, which includes the first employment candidate.

The computer software program of the first employment candidate processor may allow the first employment candidate to replace the first set of profile date with an updated set of profile data and to send the updated set of profile data to the central employment database. The computer software program of the first employment candidate processor may allow the first employment candidate to select an employment preference or take one or more employment related tests and to send the employment preference and the results of one or more employment related tests to the central employment placement database. The employment preference or one or more related test results may be part of the first employment candidates set of profile data, which may be able to be accessed by an employment agency processor from the central employment database.

The present invention also includes a method comprising entering a first set of profile data for a first employment candidate, and sending the first set of profile data to a central employment database. The method may include accessing a plurality of sets of profile data from the central employment database for a plurality of employment candidates which includes the first employment candidate; selecting one or more of the plurality of employment candidates based at least in part on the plurality of sets of profile data; and informing the employment candidates selected of their selection.

### BRIEF DESCRIPTION OF THE DRAWINGS

FIG. 1 shows an apparatus for use in accordance with a first embodiment of the present invention for providing employment placements such as temporary employment placements; and

FIG. 2 shows a flow chart of a method for providing employment placements such as temporary employment placements.

### DETAILED DESCRIPTION OF THE DRAWINGS

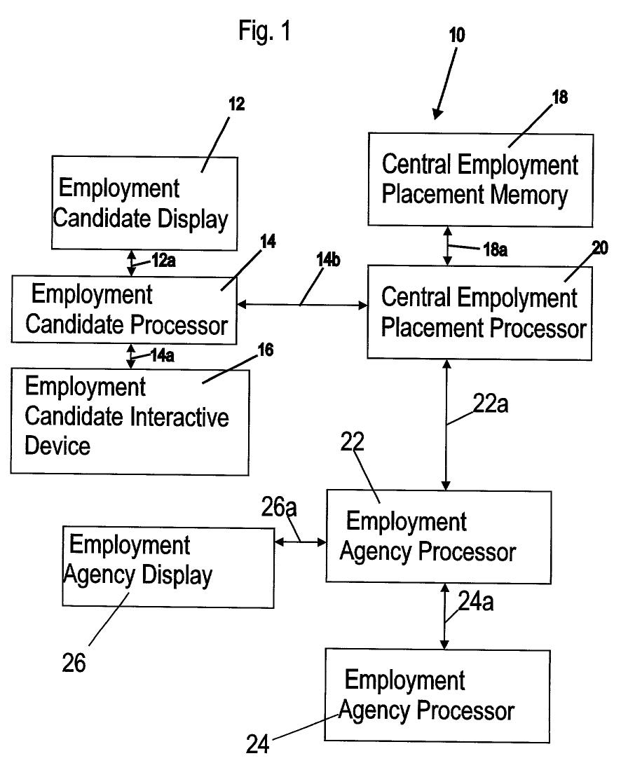

FIG. 1 shows an apparatus 10 for use in accordance with a first embodiment of the present invention for providing employment placements such as temporary employment placements. The apparatus 10 is comprised of employment candidate display 12, employment candidate processor 14, employment candidate interactive device 16, central job placement memory 18, central job placement memory 20, employment agency processor 22, employment agency interactive device 24, and employment agency display 26. The employment candidate display 12 is electrically connected to the employment candidate processor 14 via bus 12a. The employment candidate processor 14 is electrically connected to the employment candidate interactive device 16 via bus 14a. The employment candidate processor 14 is electrically connected to the central job placement processor 20 via bus 14b. The central job placement processor is electrically connected to the employment agency processor 22 via bus 22a. The employment agency processor 22 is electrically connected to the employment agency display 26 and the employment agency interactive device 24, respectively, via busses 26a and 24a. The central temp processor 20 is electrically connected to the central job placement memory via bus 18a. The busses 12a, 14a, 14b, 18a, 22a, 24a, and 26a may be any type of electrical connection such as hardwired, wireless, software, optical, or any combination thereof. The bus 14b may provide an internet connection from employment candidate processor 14 to central job placement processor 20.

The employment candidate processor 14 and the employment agency processor 22 may be personal computer processors. The employment candidate display 12 and the employment agency display 26 may be personal computer monitors. The employment candidate interactive device 16 and the employment agency interactive device 24 may be each be comprised of a keyboard and/or computer mouse. The central job placement processor 20 may be computer processor which may functions as an internet server processor. The central job placement memory 18 may be computer memory such as computer memory for a web site server.

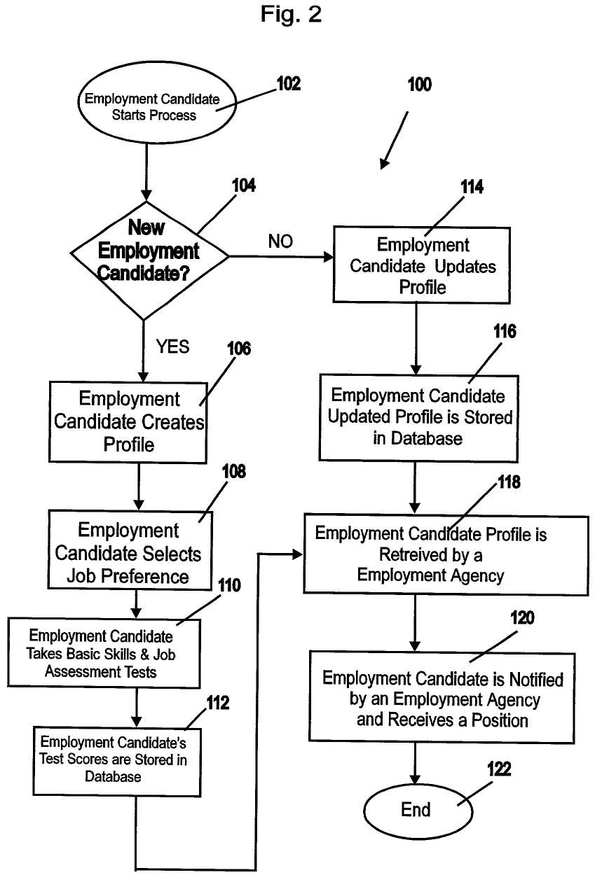

FIG. 2 shows a flow chart 100 of a method for providing employment placements such as temporary employment placements. At step 102 a employment candidate starts the process of an embodiment of the present invention. The employment candidate may, for example, cause a computer software program to run on the employment candidate processor 14 by entering information into the employment candidate interactive device 16. At step 104, the computer software program may ask the employment candidate, via for example, a message on the employment candidate display 12, whether the employment candidate is a new employment candidate. A new employment candidate would be an individual who has not previously entered data into the central job placement memory 18 regarding the individual.

If the employment candidate is a new employment candidate, the employment candidate would create a profile for himself or herself at step 106. The profile may include a plurality of data such as a employment candidate password and a employment candidate personal file. The employment candidate personal file may include the employment candidate's personal information, education background history, education and technical degrees and certificates, employment history (past and present), current and future employment and personal interest objectives, and employment opportunities that the employment candidate is seeking, such as temporary employment opportunities. The employment candidate's profile would be entered by the employment candidate via employment candidate interactive device 16 and then would be sent via bus 14a, employment candidate processor 14, bus 14b, central job placement processor 20, and bus 18a to the central job placement memory 18. The employment candidate's profile would be stored in a database in the central job placement memory 18 at step 107. The employment candidate's profile may also be stored in the employment candidate processor 14 which may include computer memory. At step 108, the new employment candidate would next select his or her job preferences to the employment preference and employment-testing portion of the computer software running on employment candidate processor 14. As part of step 108, the new employment candidate reviews listings of job classifications that interest his/her primary occupational activities. The processor 14 may retrieve from the central job placement memory 18 the listings of job classifications based on the profile entered by the employment candidate. The processor 14 may display the listings of job classifications on the employment candidate display 12. Examples of such job classification may include but are not limited to: Executive/Management, Faculty, Professional, Clerical and Secretarial Technical, skilled Crafts, Service Maintenance, Consulting, and IT Professional. The listings or headings of job classifications may include a plurality of primary occupational lists and a plurality of sub-occupational lists under each of the primary occupational lists.

Examples of primary occupational list headings are: (A) IT (Information Technology) Professional; and (B) Executive/Management. Examples of sub-occupational lists under each of the primary occupational lists are as follows:

(A) IT (Information Technology) Professional:

Sub-occupational list headings:

Web-site Developer

Java Programmer

Computer Engineer

(B) Executive/Management::

Sub-occupational list headings:

Benefits Specialist

Administrative Assistant

Instructional Developer

In general, sub-occupational lists are more specific detailed descriptions of a particular position/job under the primary occupational list and can be very lengthy due to numerous job titles under each primary occupational list.

At step 110 the employment candidate may select the employment assessment test(s) that corresponds to his/her specific sub-occupational lists as derived form the primary occupational list he/she has chosen for an employment contract, such as a temporary employment contract. The employment candidate may select these test(s) via employment candidate interactive device 16 in FIG. 1. The employment candidate may take a basic skills test to evaluate basic math, reading, and writing fundamentals. Questions for any of the tests may be displayed on employment candidate display 12 and answer may be provided by the employment candidate via employment candidate interactive device 16. At step 110 the employment candidate may take the employment assessment test(s) he/she has chosen. At step 112 the employment candidate's test scores for any test taken are stored in the central job placement memory 18, by the processor 14 through bus 14b, central job placement processor 20, and bus 18a. The employment candidate's test scores are stored in a data base in central job placement memory 18 for future retrieval by any and all employment agencies, such as any and all temporary employment agencies. The new employment candidate may be sent a copy of any test scores for his/her record such as electronically, from central job placement processor 20 via bus 14b to employment candidate processor 14, or by regular mail via the post office.

If the employment candidate is a return employment candidate, then at step 114 in FIG. 2, the employment candidate may update his or her profile. The new employment candidate may be required to enter the employment candidate's password which may allow the employment candidate to view his or her profile data on a personal profile screen on the employment candidate display 12. The profile data would be provided from the central job placement memory 18, to the central job placement processor, to the employment candidate processor 114 and then to the display 12. The employment candidate's profile may be updated by entering information through employment candidate interactive device 16. The information entered into employment candidate interactive device 16 can be sent via bus 14a to employment candidate processor 14 and then via bus 14b to central job placement processor 20. The updated profile may be stored in central job placement memory 18 at step 116.

A return employment candidate may retake assessment tests or other tests if desired. Typically the highest score from various tests, such as assessment test(s) or occupational test(s) are compiled and stored in the database of the central job placement memory 18 for review by any and all employment agencies, such as temporary employment agencies. A return employment candidate may be sent a copy of the results of the various tests, such assessment and occupational test scores, either electronically from central job placement processor 20 to the employment candidate processor 14 or via regular mail by the post office for his/her record.

A representative of an employment agency, such as a temporary employment agency, may activate computer software on the employment agency processor 22 by entering information into the interactive device 24. The representative may select a job classification he/she is searching for. A list of profiles of potential candidates in the database in central job placement memory 18 (i.e. employment candidates, like the employment candidate associated with employment candidate processor 14) satisfying the job classification selected by the representative may be displayed on the employment agency display 26 at step 118 shown in FIG. 2. The data for the profiles may be provided from the central job placement memory 18 to the central processor 20 to the employment agency processor 22 and then displayed on the employment agency display 26. The representative may select one of the applicant's profiles (i.e. one of the employment candidates who entered a profile) based on the information in the profiles that indicates the best match with the needs of the employment agency's client. The representative of the employment agency or the employment agency generally can then contact the desired employment applicant, at step 120, for placement of an employment contract, such as a temporary employment contract. The process ends at step 122.

The present invention in one or more embodiments is useful for allowing an individual or employment candidate seeking employment through one or more employment agencies such as temporary employment agencies. In one or more embodiments the present invention allows an employee to conveniently fill out only one employment application, employment skills assessment test, occupational test; and to provide past and present employment history only once, and to provide past and present employment experience only once; and to provide past and present employment expertise only once. This information obtained regarding the individual, is stored within the database of the central job placement memory such as memory 18. The central job placement processor 20 and memory 18 may provide for a “one step central business method process” and may be immediately accessible by a secured and confidential method, such as via the internet with password protection, to all employment agencies in the world in regarding the job classification or type of work where the individual is seeking employment.

A further example of the operation of one or more embodiments of the present invention is as follows. Jane Doe, a medical assistant that was laid off from work and seeking temporary employment, enters the profile information from her employment candidate computer processor, such as processor 14 into central job placement memory 18. Jane Doe takes the required past and present history requirement; and occupational and assessment tests for medical assistant; and a basic skill test for her English, Math and technical terms, and supplies this data to central job placement memory 18. This process may only take two hours and alleviates the duplication of filling out numerous employment applications, and taking duplicate occupational and assessment tests as required, for example, by all temporary employment agencies. In addition, Jane Doe's profile data is accessible for review to all employment agencies in the world (such as temporary employment agencies), for Jane Doe's placement of an employment position.

In the temporary employment example, for which this invention in various embodiments is particularly applicable, an individual seeking temporary employment, usually signs up with at least one or more employment agencies, such as temporary employment agencies, for work as a temporary employment contractor. An individual will spend an average of two and one half to four hours at each temporary employment agency he/she signs up with filling out the employment application, and taking the skills assessment and occupational test as required by the temporary employment agency. The employment applications, and the skills assessment and occupational test required by the temporary employment agencies are similar in scope and request. The present invention streamlines the application process and alleviates the duplication process sequel for filling out the employment applications and taking the skills assessment and occupational test at various temporary employment agencies.

The present invention in one or more embodiments provides more concise, objective and accurate tests results acquired from standardized testing procedures. The present invention significantly decreases the time an individual spends at each temporary employment agency, for example, for filling out the employment application and taking the skills assessment and occupational tests. The present invention eliminates duplication of initiating the assessment test and deletes numerous and redundant paperwork. The present invention may be implemented in various embodiments by a computer software program run online and/or offline via the Internet and/or Intranet. The employment agency, and particularly the temporary employment agency's administrator's cost and the time it takes to process and administer the potential employee applications, the skills assessment and occupational tests will be significantly decreased if not omitted altogether. The present invention in one or more embodiments allows the employee applicant assessment scores, employment and personal information to be accessed from any and all employment Agencies globally through confidential and secured methods. The employment applicant can use the process via a computer terminal within the privacy and convenience of the employment candidate/employment applicant's home and/or office and/or elsewhere. The temporary employee applicant can be contacted directly by any and all employment agencies globally through confidential and secured methods for a temporary employment position.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A apparatus comprising
a first employment candidate processor which runs a computer software program;
wherein the computer software program of the first employment candidate processor allows a first employment candidate to enter a first set of profile data;
and wherein the computer software program of the first employment candidate processor allows a first employment candidate to send the first set of profile data to a central employment placement database.

2. The apparatus of claim 1 further comprising
a central employment placement processor which runs a computer software program;
wherein the computer software program of the central employment placement processor allows a first employment agency processor to access the central employment placement database to examine a plurality of sets of profile data corresponding to a plurality of employment candidates, which includes the first employment candidate.

3. The apparatus of claim 1 wherein
the computer software program of the first employment candidate processor allows the first employment candidate to replace the first set of profile date with an updated set of profile data and to send the updated set of profile data to the central employment database.

4. The apparatus of claim 3 further comprising
a central employment placement processor which runs a computer software program;
wherein the computer software program of the central employment placement processor allows a first employment agency processor to access the central employment placement database to examine a plurality of sets of profile data corresponding to a plurality of employment candidates, which includes the first employment candidate.

5. The apparatus of claim 1 and wherein
wherein the computer software program of the first employment candidate processor allows the first employment candidate to select an employment preference and to send the employment preference to the central employment placement database.

6. The apparatus of claim 1 and wherein
wherein the computer software program of the first employment candidate processor allows the first employment candidate to take one or more tests related to obtaining employment and to send the results of the one or more tests to the central employment placement database.

7. The apparatus of claim 2 wherein
the central employment processor allows a first employment agency processor to access the central employment placement database to examine a plurality of sets of employment preferences for a plurality of employment candidates, which includes the first employment candidate.

8. The apparatus of claim 2 wherein
the central employment processor allows a first employment agency processor to access the central employment placement database to examine a plurality of sets of test results for a plurality of employment candidates, which includes the first employment candidate.

9. The apparatus of claim 1 wherein
the first employment candidate is a candidate for temporary employment.

10. A method comprising
entering a first set of profile data for a first employment candidate; and
sending the first set of profile data to a central employment database.

11. The method of claim 10 further comprising
accessing a plurality of sets of profile data from the central employment database for a plurality of employment candidates which includes the first employment candidate.

12. The method of claim 11 further comprising
selecting one or more of the plurality of employment candidates based at least in part on the plurality of sets of profile data.

13. The method of claim 11 further comprising
informing the employment candidates selected of their selection.

14. The method of claim 10 further comprising
replacing the first set of profile data with an updated set of profile data sending the updated set of profile data to the central employment database.

15. The method of claim 10 further comprising
selecting an employment preference for the first employment candidate and sending the employment preference to the central employment placement database.

16. The method of claim 10 further comprising
taking one or more tests related to obtaining employment for the first employment candidate and sending the results of the one or more tests to the central employment placement database.

17. The method of claim 15 further comprising
accessing the central employment placement database to examine a plurality of sets of employment preferences for a plurality of employment candidates, which includes the first employment candidate.

18. The method of claim 16 further comprising
accessing the results of one or more tests for a plurality of employment candidates, which includes the first employment candidate.
